(19) United States
(12) Patent Application Publication
(10) Pub. No.: US 2024/0294799 A1
(43) Pub. Date: Sep. 5, 2024

(54) POWDER COATING AND CRYSTALLINE DONOR AND/OR ACCEPTOR

(71) Applicant: Allnex Netherlands B.V., Bergen Op Zoom (NL)

(72) Inventors: Richard Hendrikus Gerrit BRINKHUIS, Zwolle (NL); Pengcheng YANG, Arnhem (NL)

(73) Assignee: Allnex Netherlands B.V., Bergen Op Zoom (NL)

(21) Appl. No.: 18/569,754

(22) PCT Filed: Jul. 5, 2022
(86) PCT No.: PCT/EP2022/068512

§ 371 Date: Dec. 13, 2023

(30) Foreign Application Priority Data
Jul. 5, 2021 (EP) 21183713.3

(51) Int. Cl. C09D 175/14; C08G 18/24; C08G 18/28; C08G 18/32; C08G 18/34; C08G 18/73; C09D 5/03

(52) U.S. Cl. CPC C09D 175/14; C08G 18/246; C08G 18/282; C08G 18/3206; C08G 18/341; C08G 18/73; C09D 5/03; C08G 2150/20

(57) ABSTRACT

The invention is related to a powder coating composition comprising a crosslinkable composition and a catalyst system, wherein the crosslinkable composition is formed by a crosslinkable donor component A and a crosslinkable acceptor component B that are crosslinkable by a Real Michael Addition (RMA) wherein at least part of the crosslinkable donor component A and/or a crosslinkable acceptor component B are (semi) crystalline and comprise a polyurethane backbone formed by reacting a polyisocyanate, which is substantially hexamethylene diisocyanate (HDI), with a compound (i) which is more preferably a diol; and a compound (iia) comprising at least one, preferably 1, isocyanate reactive groups, preferably a hydroxyl and at least one functional group having at least one acidic C—H donor group in activated methylene or methine, a compound (iib) comprising at least one, preferably (1), isocyanate reactive groups, preferably a hydroxyl and at least one functional group having at least one activated unsaturated acceptor groups C═C, to form the (semi) crystalline acceptor component B.

### BACKGROUND OF THE INVENTION

The invention is related to a powder coating composition that is crosslinkable via Real Michael Addition (RMA), comprising semi(crystalline) polyurethane donor or acceptor components, a method for preparing the powder coating composition, a process for coating articles using said powder coating composition, the coated articles and the semi(crystalline) polyurethane donor or acceptor components.

### DESCRIPTION OF THE RELATED ART

Powder coatings are dry, finely divided, free flowing, solid materials at room temperature and have gained popularity in recent years over liquid coatings. Powder coatings are generally cured at elevated temperatures between 120° C. and 200° C., more typically between 140° C. and 180° C. High temperatures are required to provide for sufficient flow of the binder to allow film formation and achieve good coating surface appearance, but also for achieving high reactivity for a crosslinking reaction. At lower curing temperatures, one may face reaction kinetics that will not allow short cure times when demanding full mechanical and resistance property development; on the other hand, for systems where a high reactivity of the components may be created, the coatings likely have a poor appearance due to the relatively high viscosity of such systems at such lower temperatures, rapidly increasing further as the cure reaction proceeds: the time-integrated fluidity of such systems is too low to achieve sufficient leveling (see e.g. Progress in Organic Coatings, 72 page 26-33 (2011)). Especially when targeting thinner films, flow and appearance may be limiting. Moreover, very high reactivities may lead to problems due to premature reaction when formulating powder paints in an extruder, and have limited storage stability, lowering the Tg of the powder paint improves flow, but is detrimental to the storage stability.

Crystalline components can help the flow of powder coatings systems, if they melt and plasticize the paint at cure conditions, thereby reducing melt viscosity. It is important they can do that without negatively affecting the chemical resistance or mechanical properties of the resulting network. For such components, it is preferred that they can be present in the crystalline state in the powder paint before cure, to avoid negatively affecting storage stability by already yielding too much plasticization in this stage. Also preferred is that this crystalline state is not too coarse, and can be achieved simply after melt mixing the formulation in the extruder. In addition, the melting is preferably completed at the intended low curing temperatures,

Patent application WO 2019/145472 describes a powder coating composition that provides a coating on substrates that are heat-sensitive substrates such as medium density fibre-board (MDF), wood, plastics and certain metal alloys and is able to cure at low temperature with a high curing speed and acceptable short curing times. This coating composition is curable via RMA using a catalyst system that initiates the RMA reaction.

Patent applications CN112457751 and CN112457752 describe a low temperature RMA curable composition comprising donor, acceptor and (semi) crystalline components as a vinylether polyurethane resin, or a (semi) crystalline polyester methacrylate component.

However, the crystalline vinyl ethers will act as plasticizers that will not become part of the polymer RMA network, and therefore reduce the crosslink density and chemical resistance; the polyester methacrylates described do not easily crystallize from the total formulations and therefore already reduce Tg of the powder paint before application.

Therefore, there is still a need for a low temperature curing RMA crosslinkable powder coating composition, with good storage stability, leading to good mechanical, adhesion, chemical resistance and flow properties upon cure.

### BRIEF SUMMARY OF THE INVENTION

Present invention addresses one or more of the above problems by providing a powder coating composition as described in claim 1.

Accordingly a first aspect of the invention is related to a powder coating composition comprising a crosslinkable composition and a catalyst system, wherein the crosslinkable composition is formed by a crosslinkable donor component A and a crosslinkable acceptor component B that are crosslinkable by a Real Michael Addition (RMA) reaction via the catalyst system, and which catalyst system is able to catalyze the RMA crosslinking reaction at a curing temperature below 140° C., preferably below 120° C. or even more preferably below 110° C. or below 100° C. and preferably at least 70° C., preferably at least 80, 90 or 100° C.,
wherein the crosslinkable composition comprises
a) crosslinkable donor component(s) A having at least 2 acidic C—H donor groups in activated methylene or methine, and
b) crosslinkable acceptor component(s) B having at least 2 activated unsaturated acceptor groups C═C, which react with component A by Real Michael Addition (RMA) to form a crosslinked network;
wherein at least a crosslinkable donor component A and/or a crosslinkable acceptor component B are (semi) crystalline and comprises a polyurethane backbone formed by:
reacting a polyisocyanate, which is substantially hexamethylene diisocyanate (HDI), with a compound (i) comprising at least two, preferably two, isocyanate reactive groups, preferably hydroxyls, which is more preferably a diol; and
a compound (iia) comprising at least one, preferably 1, isocyanate reactive groups, preferably a hydroxyl and at least one functional group having at least one acidic C—H donor group in activated methylene or methine, to form a (semi) crystalline donor component A; or
a compound (iib) comprising at least one, preferably 1, isocyanate reactive groups, preferably a hydroxyl and at least one functional group having at least one activated unsaturated acceptor groups C═C, to form the (semi) crystalline acceptor component B.

A second aspect is related to a crosslinkable donor component A and/or a crosslinkable acceptor component B are (semi) crystalline and comprise a polyurethane backbone formed by:
reacting a polyisocyanate, which is substantially hexamethylene diisocyanate (HDI), with a compound (i) comprising at least two, preferably two, isocyanate reactive groups, preferably hydroxyls, more preferably is a diol; and
a compound (iia) comprising at least one, preferably 1, isocyanate reactive groups, preferably a hydroxyl and at least one functional group having at least one acidic C—H donor groups in activated methylene or methine, to form a (semi) crystalline donor component A; or
a compound (iib) comprising at least one, preferably 1, isocyanate reactive groups, preferably a hydroxyl and at least one functional group having at least one activated unsaturated acceptor groups C═C, to form the (semi) crystalline acceptor component B.

A third aspect is related to a method for powder-coating a substrate comprising
a. applying a layer comprising the powder coating composition according to the first aspect, to a substrate surface wherein the substrate preferably is a temperature sensitive substrate, preferably MDF, wood, plastic, composite or temperature sensitive metal substrates like alloys and
b. heating to a curing temperature Tour between 75 and 160° C., preferably between 80 and 150° C. and more preferably between 80 and 140, 130 or even 120° C., 110° C., 100° C., preferably using infrared heating, wherein the melt viscosity at the curing temperature Tour is preferably less than 60 Pas, more preferably less than 40, 30, 20, 10 or even 5 Pas;
c. and curing at Tour for a curing time preferably less than 40, 30, 20, 15, 10 or even 5 minutes.

A fourth third aspect is related to an article coated with a powder having a the powder coating composition according to the first aspect, wherein the articles preferably have a temperature sensitive substrate preferably selected from the group of MDF, wood, plastic, composite or metal alloys and wherein preferably the crosslinking density XLD is at least 0.01, preferably at least 0.02, 0.04, 0.07 or even 0.1 mmole/ml (as determined by DMTA) and is preferably lower than 3, 2, 1.5, 1 or even 0.7 mmole/ml.

### DETAILED DESCRIPTION OF THE INVENTION

The inventors surprisingly found that a powder coating composition according to the invention wherein the composition comprises a donor A and/or acceptor B that is (semi) crystalline and has a polyurethane backbone prepared with isocyanates that are substantially HDI and a compound having at least two isocyanate reactive groups that is preferably a diol, provides a powder coating that recrystallizes well after extrusion formulation, to give a powder paint with good Tg and storage stability, and which gives a final coating with good mechanical resistance, improved adhesion and mechanical properties, and improved flow, with the crystalline components having melting temperatures in the paint compatible with low curing temperatures.

In the context of the present invention the term “(semi) crystalline compound” is a compound that has a melting temperature Tm above which the compound is liquid. In the context of the present invention, the “melting temperature” of the (semi) crystalline compound is the temperature at which the compound is completely melted when the compound is present in the composition comprising at least a crosslinkable system and a catalyst system as described in current invention, unless it is specified otherwise in the description below, as the melting temperature of the compound itself. The melting temperature reported herein are determined from Differential Scanning calorimetry (DSC) using a heating rate of 10° C./min.

In the context of the present invention, the term “(meth)acrylate” is meant to encompass both acrylate and methacrylate components.

### BRIEF DESCRIPTION OF THE FIGURES

FIG. 1. ¹H NMR spectra of cyclohexyl vinyl ether.

FIG. 2. ¹H NMR spectra of kinetic study mixture before curing.

FIG. 3. ¹H NMR spectra of kinetic study mixture after curing for 30 minutes at 110° C.

### DESCRIPTION OF EMBODIMENTS

### Crosslinkable Components

In the invention the crosslinkable composition comprises
a) crosslinkable donor component(s) A having at least 2 acidic C—H donor groups in activated methylene or methine, and
b) crosslinkable acceptor component(s) B having at least 2 activated unsaturated acceptor groups C═C, which react with component A by Real Michael Addition (RMA) to form a crosslinked network;
wherein at least part of the crosslinkable donor components A and/or the crosslinkable acceptor components B are (semi) crystalline, and comprise a polyurethane backbone formed by:
reacting a polyisocyanate, which is substantially hexamethylene diisocyanate (HDI), with a compound (i) comprising at least two, preferably two, isocyanate reactive groups, preferably hydroxyls, which is more preferably a diol; and
a compound (iia) comprising at least one isocyanate reactive group, preferably hydroxyl, and at least one, preferably one, functional group having at least one acidic C—H donor group in activated methylene or methine, to form the (semi) crystalline donor component A; or
a compound (iib) comprising at least one isocyanate reactive group, preferably hydroxyl, and at least one, preferably one functional group having at least one activated unsaturated acceptor group C═C, to form the (semi) crystalline acceptor component B.

It has surprisingly been found that (semi) crystalline donor A and/or acceptor B have a urethane backbone from hexamethylene diisocyanate (HDI) with a selected diol and the having the targeted molecular weight, provides a powder coating composition having a suitable melting temperature, that recrystallizes after extrusion, has reduced melting viscosity compared to an amorphous donor/acceptor system and provides a coating with better adhesion and flexibility compared to an amorphous donor/acceptor system.

Preferably, compound (i) is selected in a way to provide a component A or B with a melting temperature below the intended cure temperature. In one preferred embodiment the (semi) crystalline donor A and/or acceptor B component has a melting temperature below 140° C., preferably below 120° C., 110° C., 105, or even below 100° C.

In another embodiment, the (semi) crystalline donor and/or acceptor component has a melting temperature of the compound itself, i.e. when not present in the coating composition, that is below 145° C., 130° C., preferably below 120° C., 110° or even below 100° C. such as between 80 and 130° C., preferably between 80 and 120° C. The melting temperature of the (semi) crystalline donor and/or acceptor itself can be slightly higher than the melting temperature when formulated in the paint and thus when present in the coating composition.

In a preferred embodiment, compound (i) comprising at least two isocyanate reactive groups is a diol wherein the diol has:
a connecting chain between the hydroxyl groups that contain ether- or thioether groups, preferably —CH2-O—CH2-, —CH2-S—CH2-, —CH2-S—S—CH2- and the connection chain has a maximum length of 11 carbon atoms and/or heteroatoms between the hydroxyl groups; or has a connecting chain between the hydroxyl groups containing a —CH(CH3)- unit or a —CH(CH2CH3)- unit, preferably in a central position, whereby the connecting chain has a chain length that has an uneven number of carbon atoms and/or heteroatoms of less than 6 between the hydroxyl groups;
wherein the hydroxyl groups are primary hydroxyl groups and wherein the diols are not aromatic and not cycloaliphatic.

In yet another embodiment the compound (i) comprising at least two isocyanate reactive groups is a diol and is preferably selected from the group consisting of diethylene glycol; triethylene glycol; 3-methyl 1,5-pentanediol, 2-methyl 1,3-propane diol; thio diethanol; dithio diethanol; bis(hydroxyethyl)methyl amine; tetraethylene glycol; di(1,3-propanediol); di(1,4-butanediol).

In one embodiment the number average molecular weight of the (semi) crystalline donor A and/or acceptor B is between 300 and 4000 g/mol, preferably between 500 and 3000, more preferably between 1000 and 2000 g/mol.

In yet another embodiment the ratio of the isocyanate reactive groups of compound (i) and compound (iia) or (iib) related to the isocyanate groups is preferably above one, more preferably the molar ratio of the isocyanate reactive groups over isocyanate groups is between 1.0 to 1.5, more preferably from 1.01 to 1.2.

In another preferred embodiment, a (semi-crystalline) acceptor component B is used, and the compound (iib) is a hydroxyl functional (meth-)acrylate, preferably selected from the group consisting of hydroxybutyl(meth)acrylate and hydroxyethyl(meth)acrylate or a mixture thereof; or wherein the compound (iib) has a hydroxyl and a maleate, fumarate or itaconate functional group.

It is to be understood that C═C in vinyl ether is not an activated unsaturated acceptor group according to the invention. Therefor, compound (iib) comprising at least one functional group having at least one activated unsaturated acceptor groups C═C, is not a vinyl ether group.

In yet another preferred embodiment, a (semi-crystalline) donor component A is used, and the compound (iia) is a hydroxyl functional acetoacetate as in the transesterification product of a diol with an alkylacetoacetate; or a mono-hydroxyl functional component as resulting from the partial transesterification of a diol with a dialkylmalonate. In the case of using a transesterification product of diols and dialkyl malonate, also some bis-hydroxyl malonate components may be formed from double reaction of the malonate, they can be incorporated at diol compound (i).

Also disclosed is a (semi) crystalline donor A and/or acceptor B component whereby no compound (i) is used to prepare the urethane backbone.

In another embodiment the powder coating composition comprises
a. crosslinkable component A comprises at least 2 acidic C—H donor groups in activated methylene or methine in a structure Z1(—C(—H)(—R)—)Z2 wherein R is hydrogen, a hydrocarbon, an oligomer or a polymer, and wherein Z1 and Z2 are the same or different electron-withdrawing groups, preferably chosen from keto, ester or cyano or aryl groups, and preferably comprises an activated C—H derivative having a structure according to formula 1:

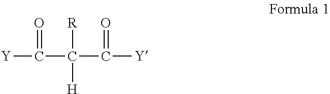

wherein R is hydrogen or an optionally substituted alkyl or aryl and Y and Y′ are identical or different substituent groups, preferably alkyl, aralkyl or aryl, or alkoxy or wherein in formula 1 the —C(═O)—Y and/or —C(═O)—Y′ is replaced by CN or aryl, no more than one aryl or wherein Y or Y′ can be NRR′ (R and R′ are H or optionally substituted alkyl) but preferably not both, wherein R, Y or Y′ optionally provide connection to an oligomer or polymer, said component A preferably being a malonate, acetoacetate, malonamide, acetoacetamide or cyanoacetate groups, preferably providing at least 50, preferably 60, 70 or even 80% of the total of C—H acidic groups in crosslinkable component A,
b. Component B comprises the at least 2 activated unsaturated RMA acceptor groups preferably originate from acryloyl, methacryloyl, itaconates, maleate or fumarate functional groups; and
   wherein at least one of the donor components A and/or acceptor components B is a (semi)crystalline component having a polyurethane backbone as described above;
   wherein preferably the composition comprises a total amount donor groups C—H and acceptor groups C═C per gram binder solids from 0.05 to 6 meq/gr binder solids and preferably the ratio of acceptor groups C═C to donor groups C—H is more than 0.1 and less than 10.

In yet another embodiment, the amount of the crystalline polyurethane components in the formulation is from 2 to 95 wt % based on total amount of crosslinkable components A and B, preferably from 2 to 70 wt %, more preferably from 3 to 50 wt %, and most preferably from 6 to 35 wt %.

In yet another embodiment, the (semi) crystalline crosslinkable components A and B are (semi) crystalline hybrid A/B components are formed by:
reacting a polyisocyanate, which is substantially hexamethylene diisocyanate (HDI), with a compound (i) comprising at least two, preferably two, isocyanate reactive groups, preferably hydroxyls, more preferably is a diol; and
a compound (iia) comprising at least one, preferably 1, isocyanate reactive groups, preferably a hydroxyl and at least one functional group having at least one acidic C—H donor groups in activated methylene or methine, to form a (semi) crystalline donor component A; and
a compound (iib) comprising at least one, preferably 1, isocyanate reactive groups, preferably a hydroxyl and at least one functional group having at least one activated unsaturated acceptor groups C═C, to form the (semi) crystalline acceptor component B.

Real Michael Addition (RMA) crosslinkable coating compositions comprising crosslinkable components A and B are generally described for use in solvent borne systems in EP2556108, EP0808860 or EP1593727 which specific description for crosslinkable components A and B are herewith considered to be enclosed.

The components A and B respectively comprise the RMA reactive donor and acceptor moieties which on curing react to form the crosslinked network in the coating. The components A and B can be present on separate molecules but can also be present on one molecule, referred to as a hybrid A/B component, or combinations thereof.

Preferably, components A and B are separate molecules and each independently in the form of polymers, oligomers, dimers or monomers. For coating applications, it is preferred at least one of component A or B preferably are oligomers or polymers. It is noted that an activated methylene group CH2 comprises 2 C—H acidic groups. Even though, after reaction of the first C—H acidic group, the reaction of the second C—H acid group is more difficult, e.g. for reaction with methacrylates, as compared to acrylates, the functionality of such activated methylene group is counted as 2. The reactive components A and B can also be combined in one A/B hybrid molecule. In this embodiment of the powder coating composition both C—H and C═C reactive groups are present in one A-B molecule.

Preferably, component A is a polymer, preferably a polyester, polyurethane, acrylic, epoxy or polycarbonate, having as a functional group a component A and optionally one or more components B, or components from catalytic system C. Also, mixtures or hybrids of these polymer types are possible. Suitably component A is a polymer chosen from the group of acrylic, polyester, polyester amide, polyester-urethane polymers.

Malonates or acetoacetates are preferred donor types in component A. In view of high reactivity and durability in a most preferred embodiment of the crosslinkable composition, component A is a malonate C—H containing compound. It is preferred that in the powder coating composition the majority of the activated C—H groups are from malonate, that is more than 50%, preferably more than 60%, more preferably more than 70%, most preferably more than 80% of all activated C—H groups in the powder coating composition are from malonate.

Preferred are oligomeric and/or polymeric malonate group-containing components such as, for example, polyesters, polyurethanes, polyacrylates, epoxy resins, polyamides and polyvinyl resins or hybrids thereof containing malonate type groups in the main chain, pendant or both.

The total amount of donor groups C—H and acceptor groups C═C per gram binder solids, independent of how they are distributed over the various crosslinkable components, is preferably between 0.05 to 6 meq/gr, more typically 0.10 to 4 meq/gr, even more preferably 0.25 to 3 meq/gr binder solids, most preferably between 0.5 to 2 meq/gr. Preferably, the stoichiometry between components A and B is chosen such that the ratio of reactive C═C groups to reactive C—H groups is more than 0.1, preferably more than 0.2, more preferably more than 0.3, most preferably more than 0.4, and, in the case of acrylate functional groups B preferably more than 0.5 and most preferably more than 0.75, and the ratio is preferably less than 10, preferably 5, more preferably less than 3, 2 or 1.5.

The malonate group-containing polyesters can be obtained preferably by the transesterification of a methyl or ethyl diester of malonic acid, with multifunctional alcohols that can be of a polymeric or oligomeric nature but can also be incorporated through a Michael Addition reaction with other components. Especially preferred malonate group-containing components for use with the present invention are the malonate group-containing oligomeric or polymeric esters, ethers, urethanes and epoxy esters and hybrids thereof, for example polyester-urethanes, containing 1-50, more preferably 2-10, malonate groups per molecule. Polymer components A can also be made in known manners, for example by radical polymerisation of ethylenically unsaturated monomers comprising monomers, for example (meth)acrylate, functionalised with a moiety comprising activated C—H acid (donor) groups, preferably an acetoacetate or malonate group, in particular 2-(methacryloyloxy)ethyl acetoacetate or -malonate. In practice polyesters, polyamides and polyurethanes (and hybrids of these) are preferred. It is also preferred that such malonate group containing components have a number average molecular weight (Mn) in the range of from about 100 to about 10000, preferably 500-5000, most preferably 1000-4000; and a Mw less than 20000, preferably less than 10000, most preferably less than 6000 (expressed in GPC polystyrene equivalents).

Suitable crosslinkable components B generally can be ethylenically unsaturated components in which the carbon-carbon double bond is activated by an electron-withdrawing group, e.g. a carbonyl group in the alpha-position. Representative examples of such components are disclosed in U.S. Pat. No. 2,759,913 (column 6, line 35 through column 7, line 45), DE-PS-835809 (column 3, lines 16-41), U.S. Pat. No. 4,871,822 (column 2, line 14 through column 4, line 14), U.S. Pat. No. 4,602,061 (column 3, line 14 20 through column 4, line 14), U.S. Pat. No. 4,408,018 (column 2, lines 19-68) and U.S. Pat. No. 4,217,396 (column 1, line 60 through column 2, line 64).

Acrylates, methacrylates, itaconates, fumarates and maleates are preferred. Itaconates, fumarates and maleates can be incorporated in the backbone of a polyester or polyester-urethane. Preferred example resins such as polyesters, polycarbonates, polyurethanes, polyamides, acrylics and epoxy resins (or hybrids thereof) polyethers and/or alkyd resins containing activated unsaturated groups may be mentioned. These include, for example, urethane (meth)acrylates obtained by reaction of a polyisocyanate with an hydroxyl group containing (meth)acrylic ester, e.g., an hydroxy-alkyl ester of (meth)acrylic acid or a component prepared by esterification of a poly-hydroxyl component with less than a stoichiometric amount of (meth)acrylic acid; polyether (meth)acrylates obtained by esterification of an hydroxyl group-containing polyether with (meth)acrylic acid; poly-functional (meth)acrylates obtained by reaction of an hydroxy-alkyl (meth)acrylate with a poly-carboxylic acid and/or a poly-amino resin; poly(meth)acrylates obtained by reaction of (meth)acrylic acid with an epoxy resin, and poly-alkyl maleates obtained by reaction of a mono-alkyl maleate ester with an epoxy resin and/or an hydroxy functional oligomer or polymer. Also, polyesters end-capped with glycidyl methacrylate are a preferred example. It is possible that the acceptor component contains multiple types of acceptor functional groups.

Most preferred activated unsaturated group-containing components B are the unsaturated acryloyl, methacryloyl and fumarate functional components. Preferably the number average functionality of activated C═C groups per molecule is 2-20, more preferably 2-10, most preferably 3-6. The equivalent weight (EQW: average molecular weight per reactive functional group) is 100-5000, more preferable 200-2000, and the number average molecular weight preferably is Mn 200-10000, more preferable 300-5000, most preferably 400-3500 g/mole, even more preferably 1000-3000 g/mole.

In view of the use in powder systems the Tg of component B is preferably above 25, 30, 35, more preferably at least 40, 45, most preferably at least 50° C. or even at least 60° C., because of the need for powder stability. The Tg is defined as measured with DSC, mid-point, heating rate 10° C./min. If one of the components has a Tg substantially higher than 50° C., the Tg of the other formulation components can be lower as will be understood by those skilled in the art.

A suitable component B is a urethane (meth)acrylate which has been prepared by reacting a hydroxy- and (meth)acrylate functional compound with isocyanate to form urethane bonds, wherein the isocyanates are preferably at least in part di- or tri-isocyanates, preferably isophorone diisocyanate (IPDI). The urethane bonds introduce stiffness on their own but preferably high Tg isocyanates are used like cyclo-aliphatic or aromatic isocyanates, preferably cycloaliphatic. The amount of such isocyanates used is preferably chosen such that said (meth)acrylate functional polymer Tg is raised above 40, preferably above 45 or 50° C.

The powder coating composition is designed preferably in such a way, that after cure, a crosslink density (using DMTA) can be determined of at least 0.025 mmole/cc, more preferably at least 0.05 mmole/cc, most preferably at least 0.08 mmole/cc, and typically less than 3, 2, 1 or 0.7 mmole/cc.

The powder coating composition should retain free flowing powder at ambient conditions and therefore preferably has a Tg above 25° C., preferably above 30° C., more preferably above 35, 40, 50° C. as the midpoint value determined by DSC at a heating rate of 10° C./min.

As described above the preferred component A is a malonate functional component. However, incorporation of malonate moieties tends to reduce the Tg and it has been a challenge to provide powder coating composition based on malonate as the dominant component A with sufficiently high Tg.

In view of achieving high Tg, the powder coating composition preferably comprises a crosslinkable composition of which crosslinkable donor component A and/or the crosslinkable acceptor component B, which may be in the form of a hybrid component A/B, comprises amide, urea or urethane bonds and/or whereby the crosslinkable composition comprises high Tg monomers, preferably cycloaliphatic or aromatic monomers or in case of polyesters, one or more monomers chosen from the group of 1,4-dimethylol cyclohexane (CHDM), tricyclodecanedimethanol (TCD diol), isosorbide, penta-spiroglycol, hydrogenated bisphenol A and tetra-methyl-cyclobutanediol.

Further, in view of achieving high Tg, the powder coating composition comprises component B or hybrid component A/B being a polyester (meth-)acrylate, a polyester urethane (meth-)acrylate, an epoxy (meth-)acrylate or a urethane (meth-)acrylate, or is a polyester comprising fumarate, maleate or itaconate units, preferably fumarate or is a polyester end-capped with isocyanate or epoxy functional activated unsaturated group.

In yet another embodiment crosslinkable components A or B or hybrid A/B are a polymer, preferably chosen from the group of acrylic, polyester, polyester amide, polyester-urethane polymers, which polymer
has a number average molecular weight Mn, as determined with GPC, of at least 450 gr/mole, preferably at least 1000, more preferably at least 1500 and most preferably at least 2000 gr/mole;
has a weight average molecular weight Mw, as determined with GPC, of at most 20000 gr/mole, preferably at most 15000, more preferably at most 10000 and most preferably at most 7500 gr/mole;
preferably has a polydispersity Mw/Mn below 4, more preferably below 3;
has an equivalent weight EQW in C—H or C═C of at least 150, 250, 350, 450 or 550 gr/mole and preferably at most 2500, 2000, 1500, 1250 or 1000 gr/mole and a number average functionality of reactive groups C—H or C═C between 1-25, more preferably 1.5-15 even more preferably 2-15, most preferably 2.5-10 C—H groups per molecule;
preferably has a melt viscosity at a temperature in the range between 100 and 140° C. less than 60 Pas, more preferably less than 40, 30, 20, 10 or even 5 Pas;
preferably comprises amide, urea or urethane bonds and/or comprises high Tg monomers, preferably cycloaliphatic or aromatic monomers, in particular polyester monomers chosen from the group of 1,4-dimethylol cyclohexane (CHDM), tricyclodecanedimethanol (TCD diol), isosorbide, penta-spiroglycol or hydrogenated bisphenol A and tetramethyl-cyclobutanediol; and/or
has a Tg above 25° C., preferably above 35° C., more preferably above 40, 50 or even 60° C. as the midpoint value determined by DSC at a heating rate of 10° C./min.

The polymer features Mn, Mw and Mw/Mn are chosen in view of on one hand the desired powder stability and on the other hand the desired low melt viscosity, but also the envisaged coating properties. A high Mn is preferred to minimize Tg reduction effects of end groups, on the other hand low Mw's are preferred because melt viscosity is very much related to Mw and a low viscosity is desired; therefore low Mw/Mn is preferred.

In view of achieving high Tg the RMA crosslinkable polymer preferably comprises amide, urea or urethane bonds and/or comprising high Tg monomers, preferably cycloaliphatic or aromatic monomers, or in case of polyesters comprises monomers chosen from the group of 1,4-dimethylol cyclohexane (CHDM), TCD diol, isosorbide, penta-spiroglycol or hydrogenated bisphenol A and tetramethyl-cyclobutanediol.

In case the RMA crosslinkable polymer is an A/B hybrid polymer it is further preferred that the polymer also comprises one or more component B groups chosen from the group of acrylate or methacrylate, fumarate, maleate and itaconate, preferably (meth)acrylate or fumarate.

In a preferred embodiment the RMA crosslinkable polymer comprising polyester, polyester amide, polyester-urethane or a urethane-acrylate which comprises urea, urethane or amide bonds derived from cycloaliphatic or aromatic isocyanates, preferably cycloaliphatic isocyanates, said polymer having a Tg of at least 40° C., preferably at least 45 or 50° C. and at most 120° C. and a number average molecular weight Mn of 450-10000, preferably 1000-3500 gr/mole and preferably a maximum Mw of 20000, 10000 or 6000 gr/mole and which polymer is provided with RMA crosslinkable components A or B or both. The polymer is obtainable for example by reacting a precursor polymer comprising said RMA crosslinkable groups with an amount of cycloaliphatic or aromatic isocyanates to increase the Tg. The amount of such isocyanates added, or urea/urethane bonds formed, is chosen such the Tg is raised to at least 40° C., preferably at least 45 or 50° C.

Preferably, the RMA crosslinkable polymer is a polyester or polyester-urethane comprising a malonate as the dominant component A and comprising a number average malonate functionality of between 1-25, more preferably 1.5-15 even more preferably 2-15, most preferably 2.5-10 malonate groups per molecule, has a GPC weight average molecular weight between 500 and 20000, preferably 1000-10000, most preferably 2000-6000 gr/mole, which has been prepared by reacting a hydroxy- and malonate functional polymer with isocyanate to form urethane bonds.

### The Catalyst System

A preferred catalyst system comprises a precursor P, an activator C and optionally a retarder T;
wherein the precursor P is a weak base with a pKa of its protonated form of more than 2, preferably more than 3, more preferably more than 4 and even more preferably at least 5 units lower than that of the activated C—H groups in donor component A; and the activator C can react with P at curing temperature, producing a strong base (CP) that can catalyze the Michael Addition reaction between A and B;
wherein the retarder T which is an acid that has a pKa of more than 2, more preferably more than 3, even more preferably more than 4 or 5 points lower than that of the activated C—H in A, and which upon deprotonation produces a weak base that can react with the activator C, producing a strong base that can catalyse the Michael Addition reaction between the crosslinkable compositions A and B.

In one embodiment, the activator C is selected from the group of epoxide, carbodiimide, oxetane, oxazoline or aziridine functional components, preferably an epoxide or carbodiimide;
the catalyst precursor P is a weak base nucleophile anion chosen from the group carboxylate, phosphonate, sulphonate, halogenide or phenolate anions or a non-ionic nucleophile, preferably a tertiary amine, or phosphine; more preferably a weak base nucleophile anion chosen from the group carboxylate, halogenide or phenolate anions or 1,4-diazabicyclo-[2.2.2]-octane (DABCO) or an N-alkylimidazole, most preferably a carboxylate, and/or
the retarder T which is preferably a protonated precursor P.

In another embodiment the activator C is a Michael acceptor comprising an activated unsaturated group C═C reactive with P, preferably and acrylate, methacrylate, fumarate, itaconate or maleate; and the catalyst precursor P is a weak base selected from the group of phosphines, N-alkylimidazoles and fluorides or is a weak base nucleophile anion X⁻ from an acidic X—H group containing compound wherein X is N, P, O, S or C, wherein anion X⁻ is a Michael Addition donor reactive with activator C; and/or retarder T, which is preferably a protonated precursor P1.

A most preferred catalyst activator C1 contains an epoxy group. Suitable choices for the epoxide as preferred activator C1 are cycloaliphatic epoxides, epoxidized oils and glycidyl type epoxides. Suitable components C1 are described e.g. in U.S. Pat. No. 4,749,728 Col 3 Line 21 to 56 and include C10-18 alkylene oxides and oligomers and/or polymers having epoxide functionality including multiple epoxy functionality. Particularly suitable mono-epoxides include, tert-butyl glycidyl ether, phenyl glycidyl ether, glycidyl acetate, glycidyl esters of versatic esters, glycidyl methacrylate (GMA) and glycidyl benzoate. Useful multifunctional epoxides include bisphenol A diglycidyl ether, as well as higher homologues of such BPA epoxy resins, glycidyl ethers of hydrogenated BPA, such as Eponex 1510 (Hexion), ST-4000D (Kukdo), aliphatic oxirane such as 13ystem13zed soybean oil, diglycidyl adipate, 1,4-diglycidyl butyl ether, glycidyl ethers of Novolac resins, glycidyl esters of diacids such as Araldite PT910 and PT912 (Huntsman), TGIC and other commercial epoxy resins. Bisphenol A diglycidyl ether, as well as its solid higher molecular weight homologues are preferred epoxides. Also useful are acrylic (co)polymers having epoxide functionality derived from glycidyl methacrylate. In a preferred embodiment, the epoxy components are oligomeric or polymeric components with an Mn of at least 400 (750, 1000, 1500). Other epoxide compounds include 2-methyl-1,2-hexene oxide, 2-phenyl-1,2-propene oxide (alpha-methyl styrene oxide), 2-phenoxy methyl-1,2-propene oxide, epoxidized unsaturated oils or fatty esters, and 1-phenyl propene oxide. Useful and preferred epoxides are glycidyl esters of a carboxylic acid, which can be on a carboxylic acid functional polymer or preferably on a highly branched hydrophobic carboxylic acid like Cardura E10P (glycidyl ester of Versatic™ Acid 10). Most preferred are typical powder crosslinker epoxy components: triglycidyl isocyanurate (TGIC), Araldite PT910 and PT912, and phenolic glycidyl ethers that are solid in nature at ambient temperature, or acrylic (co)polymers of glycidyl methacrylate.

Suitable examples of catalyst precursors P1 are weak base nucleophile anions chosen from the group carboxylate, phosphonate, sulphonate, halogenide or phenolate anions or salts thereof or a non-ionic nucleophile, preferably a tertiary amine or phosphine. More preferably, the weak base P1 is a weak base nucleophile anion chosen from the group carboxylate, halogenide or phenolate salt, most preferably carboxylate salts, or it is 1,4-diazabicyclo[2.2.2]octane (DABCO), or N-alkylimidazole. Catalyst precursor P1 is able to react with catalyst activator C1, which is preferably an epoxy, to yield a strongly basic anionic adduct which is able to start the reaction of the crosslinkable components A and B.

Another suitable example of a catalyst precursor P1 is a weak base nucleophile anion selected from the group of weak base anion X⁻ from an acidic X—H group containing compound wherein X is N, P, O, S or C, wherein anion X⁻ is a Michael Addition donor reactable with a Michael acceptor activator C1 and anion X⁻ is characterized by a pKa of the corresponding conjugate acid X—H below 8, preferably below 7 and more preferably below 6, wherein pKa is defined as the value in an aqueous environment, and in case C1 is a methacrylate, fumarate, itaconate or maleate, P1 has a pKa of the conjugated acid below 10.5, preferably below 9, more preferably below 8.

The catalyst precursor which is a weak base P1 preferably reacts with catalyst activator C1 at temperatures below 150° C., preferably 140, 130, 120 and preferably at least 70, preferably at least 80 or 90° C. on the time scale of the cure process. The reaction rate of weak base P1 with activator C1 at the cure temperature is sufficiently low to provide a useful open time, and sufficiently high to allow sufficient cure in the intended time window.

When the catalyst precursor P1 is an anion, it is preferably added as a salt comprising a cation that is not acidic. Not acidic means not having a hydrogen that competes for base with crosslinkable donor component A, and thus not inhibiting the crosslinking reaction at the intended cure temperature. Preferably, the cation is substantially non-reactive towards any components in the crosslinkable composition. The cations can e.g. be alkali metals, quaternary ammonium or phosphonium but also protonated ‘superbases’ that are non-reactive towards any of the components A, B or C in the crosslinkable composition. Suitable superbases are known in the art.

Preferably the catalyst precursor P is added as a salt comprising a cation that is not acidic, preferably a cation according to formula Y(R′)₄, wherein Y represents N or P, and wherein each R′ can be a same or different alkyl, aryl or aralkyl group possibly linked to a polymer or wherein the cation is a protonated very strong basic amine, which very strong basic amine is preferably selected from the group of amidines; preferably 1,8-diazabicyclo (5.4.0)undec-7-ene (DBU), or guanidines; preferably 1,1,3,3-tetramethylguanidine (TMG). R′ can be substituted with substituents that do not or not substantially interfere with the RMA crosslinking chemistry as is known to the skilled person. Most preferably R′ is an alkyl having 1 to 12, most preferably 1 to 4 carbon atoms.

Optionally, in some preferred embodiments, the catalyst system further comprises a retarder T, which is an acid that has a pKa of 2, preferably 3, more preferably 4 and most preferably 5 points lower than that of the activated C—H in the crosslinkable donor component A, and which upon deprotonation produces a weak base that can act as a P1 precursor, and can react with the activator C1, to produce a strong base that can catalyze the Michael Addition reaction between A and B. The retarder T is preferably a protonated precursor P1. The retarder T can be part of the catalyst precursor composition or of the catalyst activator composition. It can also be part of both the catalyst precursor composition and the catalyst activator composition. Preferably the retarder T and the protonated precursor P1 have a boiling point of at least 120° C., preferably 130° C., 150, 175, 200 or even 250° C. Preferably, retarder T is a carboxylic acid. The use of a retarder T can have beneficial effects in postponing the crosslinking reaction to allow more interdiffusion of the components during cure, before mobility limitations become significant.

In one specific embodiment, the catalyst activator C1 is an acrylate acceptor group and component P1 and T are X⁻/X—H components, preferably carboxylate/carboxylic acid compounds, having (in acid form) pKa below 8, more preferably below 7, 6 or even 5.5. Examples of useful X—H components for acrylate acceptor containing powder paint compositions include cyclic 1,3-diones as 1,3-cyclohexanedione (pKa 5.26) and dimedone (5,5-dimethyl-1,3-cyclohexanedione, pKa 5.15), ethyl trifluoroacetoacetate (7.6), Meldrum's acid (4.97). Preferably, X—H components are used that have a boiling point of at least 175° C., more preferably at least 200° C.

In another embodiment, the catalyst activator C1 is a methacrylate, fumarate, maleate or itaconate acceptor group, preferably methacrylate, itaconate or fumarate groups, and components P1 and T are X⁻/X—H components having acid pKa below 10.5, more preferably below 9.5, 8 or even below 7.

The pKa values referred to in this patent application, are aqueous pKa values at ambient conditions (21° C.). They can be readily found in literature and if needed, determined in aqueous solution by procedures known to those skilled in the art.

To be able to provide a helpful delay of the crosslinking reaction under cure conditions, the reaction of the retarder T and its deprotonated version P1 with activator C1 should take place with a suitable rate.

A preferred catalyst system comprises as catalyst activator C1 an epoxy, as catalyst precursor P1 a weak base nucleophilic anion group that reacts with the epoxide group of C1 to form a strongly basic adduct C1, and most preferably also a retarder T. In a suitable catalyst system, P1 is a carboxylate salt and C1 is epoxide, carbodiimide, oxetane or oxazoline, more preferably an epoxide or carbodiimide, and T is a carboxylic acid. Alternatively P1 is DABCO, C1 is an epoxy, and T is a carboxylic acid.

Without wishing to be bound to a theory it is believed that the nucleophilic anion P1 reacts with the activator epoxide C1 to give a strong base, but that this strong base is immediately protonated by the retarder T to create a salt (similar in function to P1) that will not directly strongly catalyse the crosslinking reaction. The reaction scheme takes place until substantially complete depletion of the retarder T, which provides for the open time because no significant amount of strong base is present during that time to significantly catalyse the reaction of the crosslinkable components A and B. When the retarder T is depleted, a strong base will be formed and survive to effectively catalyse the rapid RMA crosslinking reaction.

The features and advantages of the invention will be appreciated upon reference to the following exemplary reaction scheme.

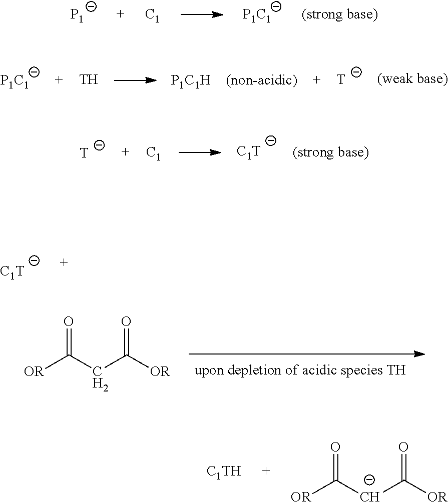

Specifically for the case of carboxylates, epoxides and carboxylic acids as P1, C1 and T species, this can be drawn up as: **replaced the picture**

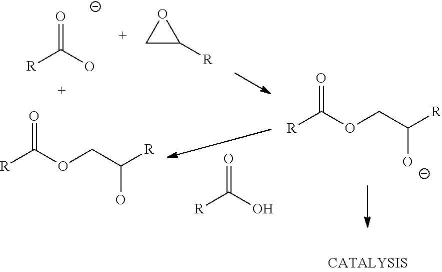

In some cases, the detailed mechanism of the reaction of the activator C1 with the precursor P1 may not be known, or subject of debate, and a reaction mechanism involving the protonated form of P1 actually involved in the reaction may be suggested. The net effect of such a reaction sequence might be similar to the sequence described based on its progress though the deprotonated form of P1. Systems where reaction might be argued to proceed along the protonated P1 pathway, are included in this invention. In this case, after depletion of the retarder T, C1 would react with a protonated P1 created from the acid-base equilibrium with Michael donor species A, and its reaction would activate crosslinking due to this acid-base equilibrium being drawn to the deprotonated Michael donor side.

The reaction scheme, if the activator would react through the protonated form of P1H would be illustrated by the next scheme:

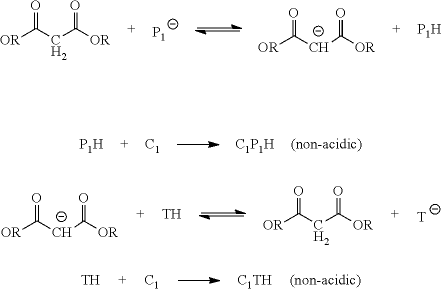

In one embodiment retarder T is a protonated anion group P1, preferably carboxylic acid T and carboxylate P1, which for example can be formed by partially neutralising an acid functional component, preferably a polymer comprising acid groups as retarder T to partially convert to anionic groups on P1, wherein the partial neutralizing is done preferably by a cation hydroxide or (bi)carbonate, preferably tetraalkylammonium or tetraalkylphosphonium cations. In another embodiment, a polymer bound component P1 can be made by hydrolysis of an ester group in a polyester with aforementioned hydroxides.

It is preferred that the boiling point of the component T and of the conjugate acid of P1 are above the envisaged curing temperature of the powder coating composition to prevent less well controlled evaporation of these catalyst system components during curing conditions. Formic acid and acetic acid are less preferred retarders T as they may evaporate during curing. Preferably, retarder T and the conjugate acid of P1 have a boiling point higher than 120° C.

Although less preferred, it is possible that at least one of the components P1, C1, or T of the catalyst system is a group on one of the crosslinkable components A or B or both. In that case it must be ensured that P1 and C1 are macrophysically in the powder coating composition. It is possible that one or more but not all groups of P1, C1 and T are on RMA crosslinkable components A or B or both. In a convenient embodiment both P1 and T are on the RMA crosslinkable component A and/or B and P1 is preferably formed by partially neutralising an acid functional polymer comprising acid groups of T with a base comprising a cation as described above to partially convert acid groups on T to anionic groups on P1. Another embodiment would have component P1 formed by hydrolysis of a polyester, e.g. of a polyester of component A, and be present as a polymeric species.

In yet another embodiment, the catalyst system comprises
an activator C in an amount between 1 and 600 μeq/gr, preferably between 10 and 400, more preferably between 20 and 200 μeq/gr relative to total weight of binder components A and B and the catalyst system,
a precursor P in an amount between 1 and 300 μeq/gr, preferably between 10 and 200, more preferably between 20 and 100 μeq/gr relative to total weight of binder components A and B and the catalyst system,
optionally a retarder T in an amount between 1 and 500, preferably between 10 and 400, more preferably between 20 and 300 μeq/gr and most preferably between 30 and 200 μeq/gr, relative to total weight of binder components A and B and the catalyst system; and
preferably wherein the equivalent amount of C1
   i. is higher than the amount of T, when present, preferably by an amount between 1 and 300 μeq/gr, preferably between 10 and 200, more preferably between 20 and 100 μeq/gr and
   ii. is preferably higher than the amount of P1 and
   iii. more preferably higher than the sum of the amount of P1 and T.

However, in case whereby the activator C1 is a Michael acceptor comprising an activated unsaturated group C═C reactive with P1, there is no relevant upper limit in concentration as in this case C1 may be also component B.

It is also possible that the catalyst system works with the amount of C1 being lower than of P1. However, this is less preferred as it will leave unreacted P1. In case the amount of C1, in particular epoxide, is higher than the amount of P1 the drawbacks are limited as it may react with P1 and T or other nucleophilic remains, but still maintain basicity after reaction or it may be left in the network, without too much problems. Nevertheless, excess of C1 may be disadvantageous in view of cost for C1 other than epoxy.

In yet another embodiment, the catalyst system comprises a precursor P and a retarder T and an activator C
wherein the weak base P respectively represents between 10 and 100 equivalent % of the sum of P and T,
preferably the amount of retarder T is 20-400 eq %, preferably 30-300 eq % of the amount of P,
wherein preferably the ratio of the equivalent amount of C to the sum of the amount of P and T is at least 0.5, preferably at least 0.8, more preferably at least 1 and preferably at most 3, more preferably at most 2,
the ratio of C to T is preferably at least 1, preferably at least 1.5, most preferably at least 2.

In a preferred embodiment the powder coating composition also comprises a precursor P and or retarder T wherein the precursor P and/or retarder T is (semi) crystalline and preferably has a polyurethane backbone prepared by reacting HDI with a compound (i) having at least two isocyanate reactive groups, preferably a diol wherein the diol (i) has:
a connecting chain between the hydroxyl groups that contain ether- or thioether groups, preferably —CH2-O—CH2-, —CH2-S—CH2-, —CH2-S—S—CH2- and the connection chain has a maximum length of 11 carbon atoms and/or heteroatoms between the hydroxyl groups; or
a connecting chain between the hydroxyl groups containing a —CH(CH3)- unit or a —CH(CH2CH3)- preferably in a central position, whereby the connecting chain has a chain length that has an uneven number of carbon atoms and/or heteroatoms of less than 6 between the hydroxyl groups;
wherein the hydroxyl groups are primary hydroxyl groups and wherein the diols are not aromatic and not cycloaliphatic.

Preferably, the (semi) crystalline precursor P and/or retarder T and the (semi) crystalline donor component A and/or acceptor component B have each a polyurethane backbone prepared by reacting HDI with the same compound (i).

### (Semi) Crystalline Donor Component a and Acceptor Component B

In a second aspect the invention is related to a crosslinkable donor component A and/or a crosslinkable acceptor component B are (semi) crystalline and comprise a polyurethane backbone formed by:
reacting a polyisocyanate, which is substantially hexamethylene diisocyanate (HDI), with a compound (i) comprising at least two, preferably two, isocyanate reactive groups, preferably hydroxyls, more preferably is a diol; and
a compound (iia) comprising at least one, preferably 1, isocyanate reactive groups, preferably a hydroxyl and at least one functional group having at least one acidic C—H donor groups in activated methylene or methine, to form a (semi) crystalline donor component A; or
a compound (iib) comprising at least one, preferably 1, isocyanate reactive groups, preferably a hydroxyl and at least one functional group having at least one activated unsaturated acceptor groups C═C, to form the (semi) crystalline acceptor component B.

The embodiments and preferred examples as described above for the (semi) crystalline donor component A and/or acceptor component B in the first aspect of the invention also apply for the second aspect of the invention.

### Substrate and Coating

The invention also relates to a method for powder-coating a substrate comprising
a. Providing the powder coating composition according to the invention,
b. Applying a layer of the powder to a substrate surface and
c. Heating to a curing temperature Tour between 75 and 140° C., preferably between 80 and 130, 120, 110, or even 100° C. and preferably using infrared heating,
d. and curing at Tour for a curing time preferably less than 40, 30, 20, 15, 10 or even 5 minutes.

The powder coating composition at the Tour preferably has a melt viscosity at the curing temperature less than 60 Pas, more preferably less than 40, 30, 20, 10 or even 5 Pas. The melt viscosity is to be measured at the very onset of the reaction or without C2 of the catalysis system.

In a preferred embodiment of the method the curing temperature is between 75 and 140° C., preferably between 80 and 120° C. and the catalyst system C is a latent catalyst system as described above which allows for powder coating a temperature sensitive substrate, preferably MDF, wood, plastic, composite or temperature sensitive metal substrates like alloys.

Therefore, the invention also relates to articles coated with a powder coating composition of the invention, preferably having a temperature sensitive substrate like MDF, wood, plastic or metal alloys and wherein preferably the crosslinking density XLD of the coating is at least 0.01, preferably at least 0.02, 0.04, 0.07 or even 0.1 mmole/cc (as determined by DMTA) and is preferably lower than 3, 2, 1.5, 1 or even 0.7 mmole/cc.

The powder coating composition, may further comprise additives such as additives selected from the group of pigments, dyes, dispersants, degassing aids, levelling additives, matting additives, flame retarding additives, additives for improving film forming properties, for optical appearance of the coating, for improving mechanical properties, adhesion or for stability properties like colour and UV stability. These additives can be melt-mixed together with one or more of the components of the powder coating composition.

Powder paints can also be designed to produce matte coatings, using similar avenues as in conventional powder coatings systems, either relying on additives or through intentional inhomogeneous crosslinking using either powder blend systems or systems based on blends of polymers of different reactivity.

Standard powder coating processing can be used, typically involving solidifying the extrudate immediately after it leaves the extruder by force-spreading the extrudate onto a cooling band. The extruded paint can take the form of a solidified sheet as it travels along the cooling band. At the end of the band, the sheet is then broken up into small pieces, preferably via a peg breaker, to a granulate. At this point, there is no significant shape control applied to the granules, although a statistical maximum size is preferred. The paint granulate is then transferred to a classifying microniser, where the paint is milled to very precise particle size distribution. This product is then the finished powder coating paint.

The invention will be illustrated by the following none limiting examples.

### Examples

### OH Value

The OHV was determined by manual titration of the prepared blanks and sample flasks. The indicator solution is made up by dissolving 0.80 g of Thymol Blue and 0.25 g of Cresol Red in 1 L of methanol. 10 drops of indicator solution is added to the flask which is then titrated with the standardized 0.5N methanolic potassium hydroxide solution. The end point is reached when the color changes from yellow to grey to blue and gives a blue coloration which is maintained for 10 seconds. The hydroxy value is then calculated according to:

$$Hydroxy Value = ( B - S ) \times N \times 56.1 / M + AV$$

Where:
B=ml of KOH used for blank titration
S=ml of KOH used for sample titration
N=normality of potassium hydroxide solution
M=sample weight (base resin)
AV=Acid Value of the base resin

The Net Hydroxy Value is defined as: Net OHV=(B−S)×N×56.1/M

### Amine Value

A freshly prepared solvent blend of 3:1 xylene:ethanol propanol is prepared. A quantity of resin is accurately weighed out into a 250 ml conical flask. 50-60 ml of 3:1 xylene:ethanol is then added. The solution is heated gently until the resin is entirely dissolved, and ensuring the solution does not boil. The solution is then cooled to room temperature and a potentiometric titration was conducted with 0.1 M hydrochloride acid until after the equivalence point.

### GPC Molecular Weight

Molar mass distribution of polymers was determined with Gel Permeation Chromatography (GPC) on Perkin-Elmer HPLC series 200 equipment, using refractive index (RI) detector and Plgel column, using as eluens THF, using calibration by polystyrene standards. Experimental molecular weights are expressed as polystyrene equivalents.

### DSC Tg

Resin and paint glass transition temperatures reported herein are the mid-point Tg's determined from Differential Scanning calorimetry (DSC) using a heating rate of 10° C./min.

### Rheological Properties of Materials

The flow and curing properties of the powder paints were characterized using a stress-controlled MCR302 rheometer of Anton-Paar fitted with an electrical heating device and corresponding heating/cooling hood (ETD400 P and H). The experiments were conducted in a parallel plate configuration of 25 mm with disposable parts. The sample material was applied at a starting temperature of 80° C. for a few minutes before applying a gap of 0.5 to 0.6 mm between the plates. With a normal force level below 15 N, heating was next started at a rate of =47 K min-1 up to 120° C. where the sample was left in isothermal conditions for 45 min, long enough to achieve full crosslinking of the sample when relevant. The complex viscosity was determined in small-strain oscillatory shear conditions with an amplitude of 2% at a frequency of 1 Hz.

### Impact Resistance

The Impact test was carried out in accordance with ASTM D 2794 on the powder coatings panels on both the coating and the reverse side. The highest impact which does not crack the coating is recorded in inch. Pounds (in.lb).

### Solvent Resistance

The solvent resistance of the cured film is measured by double rubs using a small cotton ball saturated with methyl ethyl ketone (MEK). It is judged by using a rating system (0-5, best to worst) as described below.
0. no perceptible change. Cannot be scratched with a finger-nail
1. slight loss of gloss
2. Some loss of gloss
3. the coating is very dull and can be scratched with a finger-nail
4. the coating is very dull and quite soft
5. the coating is cracked

### Abbreviations

TABLE 1
description of the abbreviations used in the examples.

| | |
|---|---|
| NPG | neopentyl glycol |
| IPA | isophthalic acid |
| TPA | terephthalic acid |
| DEG | diethylene glycol |
| IPDI | isophorone diisocyanate |
| HDI | hexamethylene diisocyanate |
| DBTL | dibutyltin dilaurate |
| BHT | butylated hydroxytoluene |
| TEAHCO₃ | tetraethylammonium bicarbonate |
| TEAOH | tetraethylammonium hydroxide |
| Methyl ethyl ketone | MEK |
| AV | acid value |
| OHV | hydroxyl value |
| wt % | weight percent |
| Mn | number average molecular weight |
| Mw | weight average molecular weight |
| Tg | glass transition Temperature |
| EQW | equivalent weight |

| | | |
|---|---|---|
| Araldite ® | glycidyl ester resin (ex Huntsman) | epoxy EQW is |
| PT912 | | 154 g/mol |
| Araldite ® | bisphenol-A epoxy resin (ex | epoxy EQW is |
| GT7004 | Huntsman) | 752 g/mol |
| EPIKOTE ™ | bisphenol-A epoxy resin (ex Hexion) | epoxy EQW is |
| 828 | | 187 g/mol |
| MODAFLOW ® | powder coating flow modifiers on | |
| P6000 | silica carrier (ex Allnex) | |
| Ken-React ® | titanium (IV) tetrakis octanolato | |
| KR46B | adduct 2 moles (di-tridecyl)hydrogen | |
| | phosphite (Kenrich petrochemicals, | |
| | Inc) | |

### Preparation of Amorphous Materials

### Preparation of Malonate Donor Resin M-1

A 5 liter round bottom reactor equipped with a 4 necked lid, metal anchor stirrer, Pt-100, packed column with top thermometer, condenser, distillate collection vessel, thermocouple and a N2 inlet was charged with 1300 g isosorbide (80%), 950 g NPG and 1983 g TPA. The temperature of the reactor was gently raised to about 100° C., and 4.5 g of Ken-React® KR46B catalyst was added. The reaction temperature was further increased gradually to 230° C., and the polymerization was progressed under nitrogen with continuous stirring until the reaction mixture is clear and the acid value is below 2 mg KOH/g. During the last part of the reaction, vacuum was applied to push the reaction to completion. The temperature was lowered to 120° C., and 660 g of diethylmalonate was added. The temperature of the reactor was then increased to 190° C. and maintained until no more ethanol was formed. Again, vacuum was applied to push the reaction to completion. After the transesterification was completed, the hydroxyl value of the polyester was measured. The final OHV was 27 mg KOH/g, with a GPC Mn of 1763 and a Mw of 5038, and a Tg (DSC) of 63° C.

### Preparation of Urethane Acrylate Acceptor Resin UA-1

A urethane-acrylate based on IPDI, hydroxy-propyl-acrylate, glycerol is prepared with the addition of suitable polymerization inhibitors, as described in e.g EP0585742. In a 5 liter reactor equipped with thermometer, stirrer, dosing funnel and gas bubbling inlet, 1020 parts of IPDI, 1.30 parts of di-butyl-tin-dilaurate (DBTL) and 4.00 parts of hydroquinone are loaded. Then 585 parts of hydroxy propylacrylate are dosed, avoiding that temperature increases to more than 50° C. Once addition is completed, 154 parts of glycerine are added. 15 minutes after the exothermic reaction subsides, the reaction product is cast on a metallic tray. The resulting urethane-acrylate is characterized by a GPC Mn of 744 and Mw of 1467, Tg (DSC) of 51° C., residual isocyanate content <0.1%, and theoretical unsaturation EQW of 392 g/mol.

### Preparation of Carboxylate Terminated Retarder Resin T-1

A 5 liter round bottom reactor equipped with a 4 necked lid, metal anchor stirrer, Pt-100, packed column with top thermometer, condenser, distillate collection vessel, thermocouple and a N2 inlet was charged with 1180 g NPG and 2000 g IPA. The temperature of the reactor was increased to 230° C., and the polymerization was progressed under nitrogen with continuous stirring until the reaction mixture is clear. The final product obtained has AV of 48 mg KOH/g and Tg (DSC) of 55° C.

### Preparation of Catalyst Precursor P-1

To prepare the catalyst precursor, a carboxylate terminated polyester resin (AV of 48) was melted and mixed with an aqueous solution of tetraethylammonium bicarbonate TEAHCO₃ (41%) using a Leistritz ZSE 18 twin-screw extruder. The extruder comprised a barrel housing nine consecutive heating zones, that were set to maintain the following temperature profile 30-50-80-120-120-120-120-100-100 (in ° C.) from inlet to outlet. The solid polyester resin was added through first zone at a rate 2 kg/h, and liquid TEAHCO₃ was injected through second zone at 0.60 kg/h. Mixing was taken place between zone 4 to 7 and the screw was set to rotate at 200 rpm. Volatiles and water generated from acid-base neutralization was removed with assistance of vacuum at zone 7. The extruded strand was immediately cooled and collected after leaving the die. The final product obtained has AV of 11 mg KOH/g, amine value of 33 KOH/g and Tg (DSC) of 48° C.

### Preparation of (Semi) Crystalline Components

### Preparation of (Semi) Crystalline Acid Retarder and Corresponding Catalyst Precursor

### CT-1 & CP-1

379.3 g DEG and 1 g DBTL was charged into a 2 liter round bottom reactor, and heated to 50° C. 497.9 HDI was then added drop-wisely into the reactor to start the reaction under nitrogen protection, and the process temperature was kept below 120° C. After that, 122.8 g succinic anhydride was charged into the reactor. The reaction is proceeded at 120° C. until the desire acid value was achieved. The final product obtained CT-1 has AV of 69 mg KOH/g, Tg (DSC) of −5° C., a max and an end DSC melting temperature of 115° C. and 125° C. respectively.

To prepare the corresponding catalyst precursor CP-1, 1790 g of CR-1 was charged into a rector and melted by heating up to 125° C. 842.5 g tetraethylammonium hydroxide (TEAOH) aqueous solution (35%) was then slowly added into the reactor, and mixed with the melted crystalline acid resin with continue stirring. Volatiles and water generated from acid-base neutralization was removed with assistance of vacuum. The final product obtained CP-1 has AV of 36 mg KOH/g, amine value of 44 mg KOH/g, Tg (DSC) of −5° C., a max and an end DSC melting temperature of 110° C. and 120° C. respectively.

### Preparation of (Semi) Crystalline Acetoacetate Donor Resin CU-Acet According to Invention

To prepare (semi) crystalline acetoacetate resin CU-Acet, a two-steps synthesis route was conducted. In the first step, triehylene glycol (TEG) was transesterified with ethylacetoacetate. Briefly, a reaction vessel was filled with 211 g of triethylene glycol, and 50 g of toluene. The mixture was heated to distil off toluene, and any water that may have been present in the TEG. 73.0 g of ethylacetoacetate was then added to the reaction mixture, along with another 50 g of toluene. At a temperature of 125° C., distillation of a toluene/ethanol mixture was continued, with occasional resupply of toluene. After a total distillation tome of 3.5 hours, 50 g of dried molsieves 4 Å were added, and the mixture allowed to slowly cool overnight. The molsieves were filtered, and the filtrate was devolatilized in the Rotavap to remove the last toluene. NMR and TLC characterization indicated that transesterification of ethyl acetoacetate was close to complete. In the second step, a reaction vessel was filled with 0.01 g DBTL and 29.3 g of the product obtained after transesterification reaction. The temperature was raised to 60° C., at which point feeding of 21.2 g of HDI was initiated. The reaction mixture was allowed to heat up to 95° C. during feeding over 45 minutes. Temperature was maintained for another hour at this temperature after completion of the feeding, and then taken from the reactor and allowed to cool. The (semi) crystalline acetoacetate donor resin CU-Acet obtained has a max and end DSC melting temperature of 73° C. and 82° C., respectively. The theoretical acetoacetate EQW is 800 g/mole.

### Preparation of Comparative (Semi) Crystalline Urethane Acrylate Resin CUA-1

As described in patent application WO 2019/145472. In a 5 liter reactor provided with thermometer, stirrer, dosing funnel and gas bubbling inlet, 833 parts of IPDI, 913 parts of HDI, 4.20 parts of DBTL and 5.00 parts of BHT are loaded. Then 395 parts of hydroxypropyl acrylate are dosed over 60 minutes, avoiding that temperature increases to more than 35° C. Once addition is completed, 896 parts of 1,6-hexanediol and 5 parts BHT are added. 15 minutes after the exothermic reaction subsides, the reaction product is cast on a metallic tray. The (semi) crystalline urethane acrylate CUA-1 obtained has a max and end DSC melting temperature of 120° C. and 140° C. respectively. Tg (DSC) of 17.7° C. and theoretical unsaturation EQW of 1004 g/mol.

### Preparation of (Semi) Crystalline Urethane Acrylate Resin CUA-2 According to Invention

504.6 g HDI, 0.1 g DBTL and 5 g BHT were charged into a 2 liter round bottom reactor and heated to 50° C. under dry air. A mixture of 288.3 g hydroxybutyl acylate and 212.2 g DEG was then added drop-wisely into the reactor to start the reaction, and the process temperature was kept below 120° C. The (semi) crystalline urethane acrylate CUA-2 obtained has a max and an end DSC melting temperature of 106° C. and 115° C. respectively. The theoretical Mn=1005 and unsaturation EQW=503 g/mol.

### Preparation of (Semi) Crystalline Urethane Acrylate Resin CUA-3 According to Invention

Similarly, 562.7 g HDI, 0.1 g DBTL and 5 g BHT were charged into a 2 liter round bottom reactor and heated to 50° C. under dry air. A mixture of 222 g hydroxyethyl acylate and 282.4 g 3-methyl-1,5-pentanediol was then added drop-wisely into the reactor to start the reaction, and the process temperature was kept below 120° C. The (semi) crystalline urethane acrylate CUA-3 obtained has a max and an end DSC melting temperature of 95° C. and 102° C., respectively. The theoretical Mn=1067 and unsaturation EQW=558 g/mol.

### Preparation of (Semi) Crystalline Urethane Acrylate Resin CUA-4

Similarly, 243.3 g HDI, 0.05 g DBTL and 0.3 g BHT were charged into a round bottom reactor and heated to 50° C. under dry air. A mixture of 112.0 g hydroxyethyl acylate and 144.8 g triethyleneglycol was then added drop-wisely into the reactor to start the reaction, and the process temperature was kept below 120° C. The (semi) crystalline urethane acrylate CUA-4 obtained has a max and an end DSC melting temperature of 82° C. and 92° C., respectively. The theoretical Mn=1037 and unsaturation EQW=519 g/mol.

### Preparation of (Semi) Crystalline Urethane Acrylate Resin CUA-5 According to Invention

Similarly, 158.8 g HDI, 0.04 g DBTL and 0.2 g BHT were charged into a round bottom reactor and heated to 50° C. under dry air. A mixture of 144.2 g hydroxybutyl acylate and 47.1 g DEG was then added drop-wisely into the reactor to start the reaction, and the process temperature was kept below 110° C. The (semi) crystalline urethane acrylate CUA-5 obtained has a max and an end DSC melting temperature of 101° C. and 108° C., respectively. The theoretical Mn=700 and unsaturation EQW=350 g/mol.

### Preparation of (Semi) Crystalline Urethane Acrylate Resin CUA-6 According to Invention

Similarly, 187.9 g HDI, 0.04 g DBTL and 0.2 g BHT were charged into a round bottom reactor and heated to 50° C. under dry air. A mixture of 68.8 g hydroxybutyl acylate and 93.3 g DEG was then added drop-wisely into the reactor to start the reaction, and the process temperature was kept below 135° C. The (semi) crystalline urethane acrylate CUA-6 obtained has a max and an end DSC melting temperature of 119° C. and 134° C., respectively. The theoretical Mn=1468 and unsaturation EQW=734 g/mol.

### Preparation of (Semi) Crystalline Urethane Acrylate Resin CUA-7 According to Invention

Similarly, 121.5 g HDI, 0.03 g DBTL and 0.2 g BHT were charged into a round bottom reactor and heated to 50° C. under dry air. A mixture of 69.9 g hydroxybutyl acylate and 58.7 g thiodiethanol was then added drop-wisely into the reactor to start the reaction, and the process temperature was kept below 135° C. The (semi) crystalline urethane acrylate CUA-7 obtained has a max and an end DSC melting temperature of 132° C. and 138° C., respectively. The theoretical Mn=1032 and unsaturation EQW=516 g/mol.

### Preparation of (Semi) Crystalline Urethane Acrylate Resin CUA-8 According to Invention

Similarly, 113.3 g HDI, 0.04 g DBTL and 0.2 g BHT were charged into a round bottom reactor and heated to 50° C. under dry air. A mixture of 71.1 g hydroxybutyl acylate and 65.7 g 2-hydroxyethyl disulfide was then added drop-wisely into the reactor to start the reaction, and the process temperature was kept below 135° C. The (semi) crystalline urethane acrylate CUA-8 obtained has a max and an end DSC melting temperature of 130° C. and 140° C., respectively. The theoretical Mn=1014 and unsaturation EQW=507 g/mol.

### Preparation of (Semi) Crystalline Urethane Acrylate Resin CUA-9 According to Invention

Similarly, 139.7 g HDI, 0.04 g DBTL and 0.2 g BHT were charged into a round bottom reactor and heated to 50° C. under dry air. A mixture of 58.1 g hydroxyethyl acylate and 52.3 g methyl propanediol was then added drop-wisely into the reactor to start the reaction, and the process temperature was kept below 150° C. The (semi) crystalline urethane acrylate CUA-9 obtained has a max and an end DSC melting temperature of 132° C. and 142° C., respectively. The theoretical Mn=1000 and unsaturation EQW=500 g/mol.

### Preparation of (Semi) Crystalline Urethane Acrylate Resin CUA-10 According to Invention

Similarly, 237.6 g HDI, 0.05 g DBTL and 0.3 g BHT were charged into a round bottom reactor and heated to 50° C. under dry air. A mixture of 116.1 g hydroxyethyl acylate and 146.3 g 2-Butyl-2-ethyl-1,3-propanediol was then added drop-wisely into the reactor to start the reaction, and the process temperature was kept below 100° C. The (semi) crystalline urethane acrylate CUA-10 obtained has a max and an end DSC melting temperature of 37° C. and 63° C., respectively. The theoretical Mn=1000 and unsaturation EQW=500 g/mol.

### Preparation of (Semi) Crystalline Urethane Acrylate Resin CUA-11 According to Invention

Similarly, 121.7 g HDI, 0.05 g DBTL and 0.3 g BHT were charged into a round bottom reactor and heated to 50° C. under dry air. A mixture of 80.0 g hydroxybutyl acylate and 56.5 g N-methyl diethanolamine was then added drop-wisely into the reactor to start the reaction, and the process temperature was kept below 100° C. The (semi) crystalline urethane acrylate CUA-11 obtained has a max and an end DSC melting temperature of 56° C. and 67° C., respectively. The theoretical Mn=1002 and unsaturation EQW=501 g/mol.

### Preparation of (Semi) Crystalline Urethane Methacrylate Resin CUMA-1 According to Invention

504.6 g HDI, 1 g DBTL and 5 g BHT were charged into a 2 liter round bottom reactor and heated to 50° C. under dry air. A mixture of 260.3 g hydroxyethyl methacrylate and 212.2 g DEG was then added drop-wisely into the reactor to start the reaction, and the process temperature was kept below 120° C. The (semi) crystalline urethane methacrylate CUMA-1 obtained has a max and an end DSC melting temperature of 110° C. and 115° C. respectively. The theoretical Mn=977 and unsaturation EQW=489 g/mol.

### Preparation of Comparative (Semi) Crystalline Vinyl Ether Urethane Resin CVE-1

As described in patent application CN112457751. 1 g 4-hydroxybutyl vinyl ether, 0.02 g DBTL and 0.6 g BHT were charged into a four-necked reactor provided with a thermometer, a stirrer and a distillation device. The mixture was stirred under the protection of nitrogen and was heated to 40° C. 42.06 g HDI was then slowly dropwise added into the reactor to start the reaction, and the process temperature was kept below 110° C. The reaction was allowed to be proceed for 30 minutes at 110° C. after charging all HDI. Finally, vacuum was applied to remove low-molecular volatile matters. The (semi) crystalline vinyl ether CVE-1 obtained has a max and an end DSC melting temperature of 98° C. and 107° C. respectively. The theoretical unsaturation EQW=200 g/mol.

### Preparation of Comparative (Semi) Crystalline Vinyl Ether Urethane Resin CVE-2

As described in patent application CN112457751. 44.7 g 4-hydroxybutyl vinyl ether, 8.7 g DEG, 0.02 g DBTL and 0.6 g BHT were charged into a four-necked reactor provided with a thermometer, a stirrer and a distillation device. The mixture was stirred under the protection of nitrogen and was heated to 40° C. 42.3 g HDI was then slowly dropwise added into the reactor to start the reaction, and the process temperature was kept below 95° C. The reaction was allowed to be proceed for 30 minutes at 95° C. after charging all HDI. Finally, vacuum was applied to remove low-molecular volatile matters. The (semi) crystalline vinyl ether CVE-2 obtained has a max and an end DSC melting temperature of 87° C. and 104° C. respectively. The theoretical unsaturation EQW=260 g/mol.

### Powder Coating Compositions Preparations

To prepare the powder coating compositions, the raw materials were first premixed in a high speed Thermoprism Pilot Mixer 3 premixer at 1500 rpm for 20 seconds before being extruded in a Baker Perkins (formerly APV) MP19 25: 1 L D twin screw extruder. The extruder speed was 250 rpm and the four extruder barrel zone temperatures were set at 15, 25, 100 and 100° C. for extruding amorphous resins, or 15, 25, 120 and 100° C. for extruding (semi) crystalline resins. Following extrusion, the extrudates were grounded using a Retsch GRINDOMIX GM 200 knife mill. The grounded extrudates were sieved to below 100 μm using Russel Finex 100-micron mesh Demi Finex laboratory vibrating sieves.

### Results

### Curing Kinetic of Vinyl Ether Urethane and Urethane Acrylate.

TABLE 2
Curing kinetic results of cyclohexyl vinyl ether and butyl acrylate.

| | Initial | Initial | Concentration | Concentration | Concentration |
|---|---|---|---|---|---|
| | theoretical | concentrations | after curing | after curing | after curing |
| | concentrations | by ¹H NMR | for 10 mins at | for 20 mins at | for 30 mins at |
| Components | (mmol/g) | (mmol/g) | 110° C. | 110° C. | 110° C. |
| cyclohexyl | 1.92 | 1.79 | 1.79 | 1.79 | 1.78 |
| vinyl ether | | | | | |
| butyl acrylate | 3.89 | 3.47 | 2.46 | 0.92 | 0.83 |

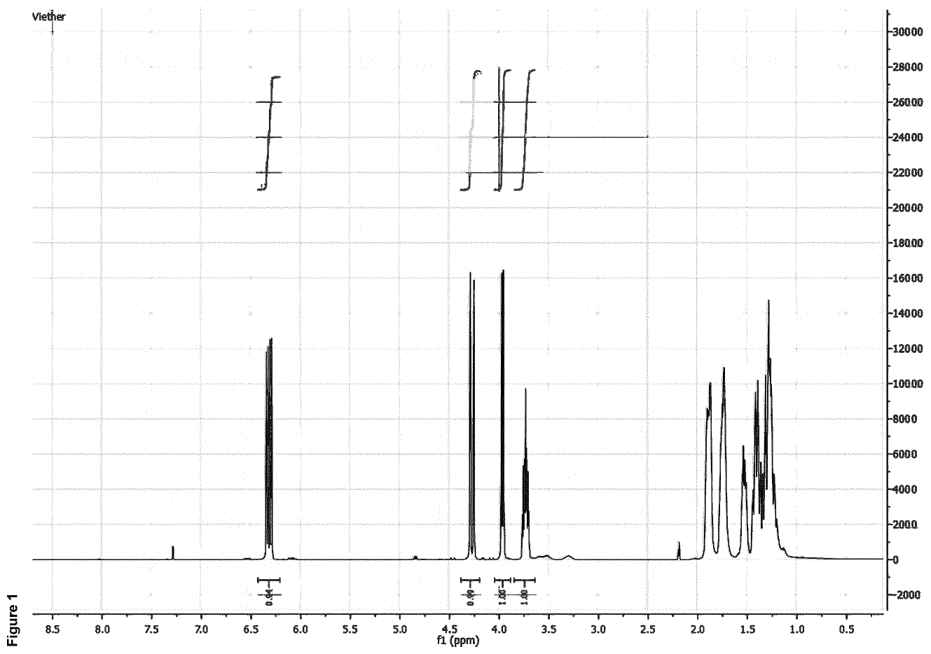

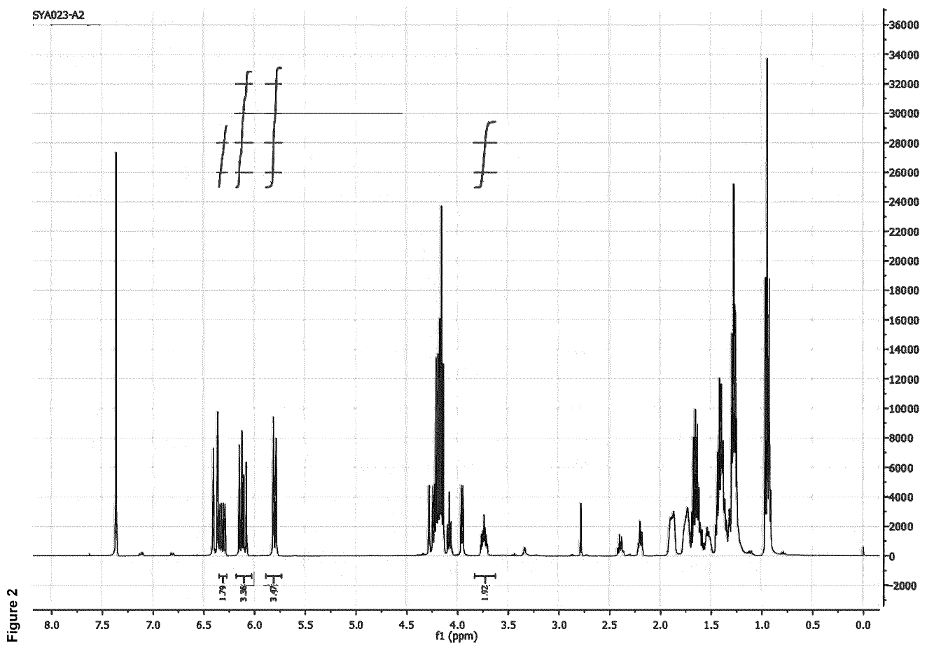

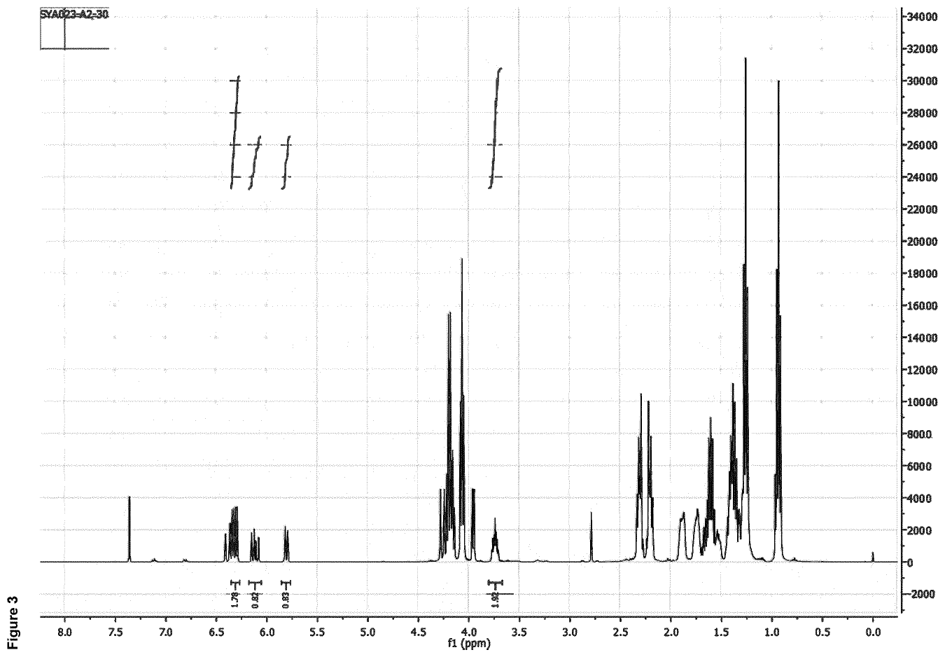

Patent application CN112457751 described using vinyl ether urethane participating the crosslinking reaction of powder coating that cured via real Michael addition (RMA) reaction. In this patent, a powder coating example prepared using malonate donor resin, urethane acrylate and vinyl ether urethane was given. The paint was formulated in the stoichiometry to have a vinyl/acrylate/C—H2 of 1.25/2.54/1, and a tertiary amine catalyst concentration of 48 meq. It was demonstrated such paint can be cured at 100° C. and offered good solvent resistance. We believe that vinyl ether urethane is not suitable as an acceptor resin in RMA reaction and can't participate in the crosslinking reaction. In view this problem, we conducted a model study to verify the reactivity of acrylate and vinyl ether in RMA. Diethyl malonate, butyl acrylate, cyclohexyl vinyl ether and 1,4-Diazabicyclo[2.2.2]octane (DABCO) were selected as model compounds for malonate donor, acrylate acceptor, vinyl ether and tertiary amine catalyst. EPIKOTE™ 828 was selected as activator. More specifically, 4.01 g diethyl malonate, 8.14 g butyl acrylate, 3.95 g cyclohexyl vinyl ether, 0.09 g DABCO and 0.15 g EPIKOTE™ 828 were mixed together in a small round bottom flack to achieve a stoichiometry ratio in vinyl/acrylate/C—H2 of 1.25/2.54/1 and a catalyst concentration of 48 meq. The mixture was heated to 110° C., and a sample was taken every 10 minutes interval for kinetic studies using 1H NMR. The signal at 3.68-3.78 ppm assigned to CH next to the ether group is used as internal standard to compare with the vinyl CH at 6.25-6.35 ppm, and the acrylate CH at 5.75-5.85 pm. The integrated 1H NMR spectrum of cyclohexyl vinyl ether, the mixture before curing and after curing at 110° C. for 30 minutes are shown in FIG. 1-3 and the results are summarized in table 2.

It is clear from this study that urethane acrylate has been consumed and likely via RMA, as concentration of acrylate decreased from 3.47 mmol/g to 0.83 mmol/g after curing at 110° C. for 30 minutes. In contrast, the concentration of cyclohexyl vinyl ether remained constant. Therefore, no cyclohexyl vinyl ether has been reacted and has not became part of crosslinked network after the same curing cycle.

To further testing vinyl ether urethane as acceptor resin in RMA powder coating, we prepared two crystalline vinyl ether urethane resins CVE-1 and CVE-2 according to patent application CN112457751. In comparative examples PW1-PW2, powder paints were formulated with these two resins as acceptor resin, in the stoichiometry to have a vinyl/C—H2 ratio of 1.5:1, 50 meq of catalyst precursor, 50 meq of acid retarder and 200 meq activator, as listed in Table 3. All paints were sprayed onto aluminum and steel panels with a film thickness between 80-100 μm, and cured for 22 minutes at 120° C. The analysis and application results of the paints are summarized in Table 4. Both PW1 and PW2 have very poor solvent resistance, because vinyl ether urethane has not reacted with the donor resin to form crosslinked films, as predicted by the model study. This is also supported by the DSC isothermal analyses at 120° C. that only small reaction enthalpies (delta H) were obtained.

TABLE 3
Comparative powder coating composition PW1-PW2.

| | Comparative powder coating compo- | |
|---|---|---|
| | sitions (values in parts by weight) | |
| | PW1 | PW2 |
| | (#145) | (#146) |
| Malonate M-1 | 558 | 522 |
| vinyl ether urethane resin CVE-1 | 168 | |
| vinyl ether urethane resin CVE-2 | | 204 |
| Crystalline catalyst precursor CP-1 | 63 | 63 |
| Retarder resin R-1 | 38 | 38 |
| Araldite ® GT 7004 | 163 | 163 |
| Modaflow P6000 | 10 | 10 |
| Total | 1000 | 1000 |

In examples PW3-PW4 (comparative) and PW5-PW7 (inventive), powder paints were formulated with urethane acrylate as acceptor resins, in the stoichiometry to have a acrylate/C—H2 ratio of 1.5:1 (except PW4 which was formulated to have same amount of semi crystalline acceptor resin as PW5, the acrylate/C—H2=0.75), 50 meq of catalyst precursor, 75 meq of acid retarder and 225 meq activator. All paints were sprayed onto aluminum and steel panels with a film thickness between 80-100 μm, and cured for 22 minutes at 120° C. The analysis and application results of the paints are summarized in Table 6.

PW3 is a comparative paint prepared with only amorphous components. The paint has a Tg of 52° C. and can be well cured after 22 mins at 120° C., as evidenced by good solvent resistance. However, it has poor adhesion on both aluminum and steel substrates and no impact resistance at all.

TABLE 4
Summary of application and DSC analysis
results for powder paints PW1 and PW2.

| | | | | DSC | DSC | Delta H | Delta H due to |
|---|---|---|---|---|---|---|---|
| | Mech. | | | Paint | cured | due to | crosslinking |
| Paint | Properties | | Solvent | Tg | film Tg | melting | reactions at |
| No. | (in · lb) | Adhesion | Resistance | (° C.) | (° C.) | (J/g) | 120° C. (J/g) |
| PW1 | 20 | GT0 | 5 | 36 | 17.3 | 24.9 | 4.7 |
| PW2 | 60 | GT1 | 4 | 35 | 17.5 | 34.3 | 1.8 |

PW4 is a comparative example formulated with (semi) crystalline urethane acrylate CUA-1 as acceptor resin. CUA-1 was prepared according to prior art patent application WO 2019/145472. CUA-1 is unlikely to recrystallize in the paint after extrusion, and DSC indicated a very low amount crystal present in paint (low delta H due to melting). This leads to a rather low paint Tg of 30° C., which can cause storage instability. In addition, rheological analysis of PW4 at 120° C. indicated a higher melt viscosity compare to PW5 and PW6 (see Table 6). This is because of relatively high Tg of CUA-1 and results less plasticization after completely melting. The solvent resistance of PW4 is also rather poor due to the high EQW of CUA-1.

PW5 and PW6 are powder examples formulated with (semi) crystalline urethane acrylate CUA-2 as acceptor resin. In PW5, a mixture of amorphous and (semi) crystalline urethane acrylate in 1/1 ratio was used. Compare to PW3, introducing (semi) crystalline urethane acrylate has significantly improved adhesion on metal substrates and impact resistance (see Table 5). Most CUA-2 is believed to have recrystallized in paints after extrusion and its impact on paint Tg is much lower than CUA-1. Consequently, much higher delta H due to melting due to presence of crystals were measured for these two paints. CUA-2 also has the advantage over CUA-1 of offering stronger plasticization and lead to lower melt viscosity. A paint with lower melt viscosity has higher flow potential and likely to achieve better appearance. Good solvent resistances were achieved for both paints.

TABLE 5
Powder coating composition PW3-PW7.

| | Comparative powder coating compositions | | | | |
|---|---|---|---|---|---|
| | (values in parts by weight) | | | | |
| | PW3 | PW4 | PW5 | PW6 | PW7 |
| Malonate M-1 | 426 | 414 | 414 | 433 | 397 |
| Urethane-acrylate UA-1 | 252 | | | 165 | 157 |
| Catalyst precursor P-1 | 84 | | | | 69 |
| Crystalline urethane-acrylate | | 312 | | | |
| CUA-1 | | | | | |
| Crystalline urethane-acrylate | | | 312 | 128 | |
| CUA-2 | | | | | |
| Crystalline urethane-acrylate | | | | | 181 |
| CUA-3 | | | | | |
| Crystalline catalyst precursor | | 63 | 63 | 63 | |
| CP-1 | | | | | |
| Retarder resin R-1 | 65 | 38 | 38 | 38 | 53 |
| Araldite ® GT 7004 | 163 | 163 | 163 | 163 | 133 |
| Modaflow P6000 | 10 | 10 | 10 | 10 | 10 |
| Total | 1000 | 1000 | 1000 | 1000 | 1000 |

TABLE 6
Summary of application, DSC analysis and rheology results of powder paints PW3-PW7.

| | | | | | | | Delta H due to | minimum |
|---|---|---|---|---|---|---|---|---|
| | | | | DSC | DSC | Delta H | crosslinking | melt |
| | Mech. | | | Paint | cured | due to | reactions at | viscosity |
| Paint | Properties | | Solvent | Tg | film Tg | melting | 120° C. | at 120° C. |
| No. | (in · lb) | Adhesion | Resistance | (° C.) | (° C.) | (J/g) | (J/g) | (Pa · s) |
| PW3 | 0 | GT4 | 1 | 52 | 90 | n/a | 41.5 | 415 |
| PW4 | 0 | GT0 | 3-4 | 29 | 51 | 4.8 | 27.8 | 186 |
| PW5 | 50 | GT0 | 1 | 43 | 56 | 21.8 | 37.3 | 108 |
| PW6 | 60 | GT0 | 1 | 43 | 63 | 13.5 | 36.7 | 138 |
| PW7 | 50 | GT0 | 0-1 | 49 | 74 | 8.1 | 35.9 | 143 |

PW7 is a powder examples formulated with a mixture of amorphous urethane acrylate resin and (semi) crystalline urethane acrylate CUA-3 in 1/1 ratio. Compare to PW3, introducing (semi) crystalline urethane acrylate has significantly improved adhesion on metal substrates and impact resistance (see Table 5). The solvent resistance remains good. Most CUA-3 is believed to have recrystallized in paints after extrusion and its impact on paint Tg is relatively low. This is evidenced by a large delta H due to melting obtained by DSC analysis. CUA-3 has the advantage of having melting temperatures <100° C., and therefore it is more suitable for preparing paints that to be cured 100-120° C.

A number of (semi) crystalline resin based on polyurethane backbone has been prepared. By using different type of diols, for example DEG, 3-methyl-1,5-pentandiol, triethyleneglycol, thiodiethanol, 2-Hydroxyethyl disulphide, N-methyl diethanolamine and 2-butyl-2-ethyl-1,3-propanediol, we demonstrated the choice of diols has an impact on the melting temperature of the obtained (semi) crystalline resin. In addition, the molecular weight of (semi) crystalline resin also has influence on its melting temperature. For instance, CUA-2, CUA-5 and CUA-6 were all prepared using DEG, but having theoretical Mn of 1005, 700 and 1468, respectively. The resulted melting temperature is 115, 108 and 134° C., respectively.

1. A powder coating composition comprising a crosslinkable composition and a catalyst system, wherein the crosslinkable composition is formed by a crosslinkable donor component A and a crosslinkable acceptor component B that are crosslinkable by a Real Michael Addition (RMA) reaction via the catalyst system, and which catalyst system is able to catalyze the RMA crosslinking reaction at a curing temperature below 140° C., preferably below 120° C. or even more preferably below 110° C. or below 100° C. and preferably at least 70° C., preferably at least 80, 90 or 100° C.,
wherein the crosslinkable composition comprises
a) crosslinkable donor component(s) A having at least 2 acidic C—H donor groups in activated methylene or methine, and
b) crosslinkable acceptor component(s) B having at least 2 activated unsaturated acceptor groups C═C, which react with component A by Real Michael Addition (RMA) to form a crosslinked network;
wherein at least part of the crosslinkable donor component A and/or a crosslinkable acceptor component B are (semi) crystalline and comprise a polyurethane backbone formed by:
reacting a polyisocyanate, which is substantially hexamethylene diisocyanate (HDI), with a compound (i) comprising at least two, preferably two, isocyanate reactive groups, preferably hydroxyls, which is more preferably a diol; and
a compound (iia) comprising at least one, preferably 1, isocyanate reactive groups, preferably a hydroxyl and at least one functional group having at least one acidic C—H donor group in activated methylene or methine, to form a (semi) crystalline donor component A; or
a compound (iib) comprising at least one, preferably 1, isocyanate reactive groups, preferably a hydroxyl and at least one functional group having at least one activated unsaturated acceptor groups C═C, to form the (semi) crystalline acceptor component B.

2. The powder coating composition according to claim 1, wherein the (semi) crystalline donor A and/or acceptor B is partially in a crystalline state, and has a melting temperature below 140° C., preferably below 120° C., 110 or even below 100° C.

3. The powder coating composition according to claim 1, wherein compound (i) comprising at least two isocyanate reactive groups is a diol wherein the diol has:
a connecting chain between the hydroxyl groups that contain ether- or thioether groups, preferably-CH2-O—CH2-, —CH2-S—CH2-, —CH2-S—S—CH2- and the connection chain has a maximum length of 11 carbon atoms and/or heteroatoms between the hydroxyl groups; or
has a connecting chain between the hydroxyl groups containing a —CH(CH3)- unit or a —CH(CH2CH3)- unit, preferably in a central position, whereby the connecting chain has a chain length that has an uneven number of carbon atoms and/or heteroatoms of less than 6 between the hydroxyl groups;
wherein the hydroxyl groups are primary hydroxyl groups and wherein the diols are not aromatic and not cycloaliphatic.

4. The powder coating composition according to claim 1, wherein the diol is selected from the group consisting of diethylene glycol; triethylene glycol; 3-methyl 1,5-pentanediol, 2-methyl 1,3-propane diol; thio diethanol; dithio diethanol; bis(hydroxyethyl)methyl amine; tetraethylene glycol; di(1,3-propanediol); di(1,4-butanediol).

5. The powder coating composition according to claim 1, wherein the number average molecular weight of the (semi) crystalline donor A and/or acceptor B is between 300 and 4000 g/mol, preferably between 500 and 3000, more preferably between 1000 and 2000 g/mol.

6. The powder coating composition according to claim 1, wherein the ratio of the isocyanate reactive groups of compound (i) and compound (iia) or (iib) related to the isocyanate groups is preferably above one, more preferably the molar ratio of the isocyanate reactive groups over isocyanate groups is between 1.0 to 1.5, more preferably from 1.01 to 1.2.

7. The powder coating composition according to claim 1, wherein the (semi)crystalline acceptor component B is used, wherein the compound (iib) is a hydroxyl functional (meth-)acrylate, preferably selected from the group consisting of hydroxybutyl(meth)acrylate and hydroxyethyl(meth)acrylate or a mixture thereof; or wherein the compound (iib) has a hydroxyl and a maleate, fumarate or itaconate functional group.

8. The powder coating composition according to claim 1, wherein a semi(crystalline) donor component A is used, in which compound (iia) is a transesterification product of a diol with an alkylacetoacetate or a dialkylmalonate.

9. The powder coating composition according to claim 1 wherein
a. crosslinkable components A comprise at least 2 acidic C—H donor groups in activated methylene or methine in preferably malonate, acetoacetate, malonamide, acetoacetamide or cyanoacetate;
b. components B comprise the at least 2 activated unsaturated RMA acceptor groups preferably originate from acryloyl, methacryloyl, itaconates, maleate or fumarate functional groups; and
wherein at least one of the donor components A and/or acceptor components B is a material having a the polyurethane backbone formed as described in claim 1;
wherein preferably the composition comprises a total amount donor groups C—H and acceptor groups C═C per gram binder solids from 0.05 to 6 meq/gr binder solids and preferably the ratio of acceptor groups C═C to donor groups C—H is more than 0.1 and less than 10.

10. The powder coating composition according to claim 1, wherein the amount of the crystalline polyurethane components in the formulation is from 2 to 95 wt % based on total amount of crosslinkable components A and B, preferably from 2 to 70 wt %, more preferably from 3 to 50 wt %, and most preferably from 6 to 35 wt %.

11. The powder coating composition according to claim 1, wherein the (semi) crystalline crosslinkable components A and B are (semi) crystalline hybrid A/B components
formed by:
reacting a polyisocyanate, which is substantially hexamethylene diisocyanate (HDI), with a compound (i) comprising at least two, preferably two, isocyanate reactive groups, preferably hydroxyls, more preferably is a diol; and
a compound (iia) comprising at least one, preferably 1, isocyanate reactive groups, preferably a hydroxyl and at least one functional group having at least one acidic C—H donor groups in activated methylene or methine, to form a (semi) crystalline donor component A; and
a compound (iib) comprising at least one, preferably 1, isocyanate reactive groups, preferably a hydroxyl and at least one functional group having at least one activated unsaturated acceptor groups C═C, to form the (semi) crystalline acceptor component B.

12. The powder coating composition according to claim 1, wherein the catalyst system comprises a precursor P, an activator C and optionally a retarder T;
wherein the precursor P is a weak base with a pKa of its protonated form of more than 2, preferably more than 3, more preferably more than 4 and even more preferably at least 5 units lower than that of the activated C—H groups in donor component A; and the activator C can react with P at curing temperature, producing a strong base (CP) that can catalyze the Michael Addition reaction between A and B;
wherein the retarder T which is an acid that has a pKa of more than 2, more preferably more than 3, even more preferably more than 4 or 5 points lower than that of the activated C—H in A, and which upon deprotonation produces a weak base that can react with the activator C, producing a strong base that can catalyse the Michael Addition reaction between the crosslinkable compositions A and B.

13. The powder coating composition according to claim 1, wherein the precursor P and/or retarder T is (semi) crystalline and preferably has a polyurethane backbone prepared by reacting HDI with a compound (i) having at least two isocyanate reactive groups, preferably a diol wherein the diol (i) has:
a connecting chain between the hydroxyl groups that contain ether- or thioether groups, preferably-CH2-O—CH2-, —CH2-S—CH2-, —CH2-S—S—CH2- and the connection chain has a maximum length of 11 carbon atoms and/or heteroatoms between the hydroxyl groups; or
a connecting chain between the hydroxyl groups containing a —CH(CH3)- unit or a —CH(CH2CH3)- preferably in a central position, whereby the connecting chain has a chain length that has an uneven number of carbon atoms and/or heteroatoms of less than 6 between the hydroxyl groups;
wherein the hydroxyl groups are primary hydroxyl groups and wherein the diols are not aromatic and not cycloaliphatic.

14. The powder coating composition according to claim 13, wherein the (semi) crystalline precursor P and/or retarder T and the (semi) crystalline donor component A and/or acceptor component B have each a polyurethane backbone prepared by reacting HDI with the same compound (i).

15. A crosslinkable donor component A and/or a crosslinkable acceptor component B are (semi) crystalline and comprise a polyurethane backbone formed by:
reacting a polyisocyanate, which is substantially hexamethylene diisocyanate (HDI), with a compound (i) comprising at least two, preferably two, isocyanate reactive groups, preferably hydroxyls, more preferably is a diol; and
a compound (iia) comprising at least one, preferably 1, isocyanate reactive groups, preferably a hydroxyl and at least one functional group having at least one acidic C—H donor groups in activated methylene or methine, to form a (semi) crystalline donor component A; or
a compound (iib) comprising at least one, preferably 1, isocyanate reactive groups, preferably a hydroxyl and at least one functional group having at least one activated unsaturated acceptor groups C═C, to form the (semi) crystalline acceptor component B.

16. The crosslinkable donor component A and/or a crosslinkable acceptor component B, having the features as specified in claim 1.

17. A method for powder-coating a substrate comprising
a. applying a layer comprising the powder coating composition according to claim 1, to a substrate surface wherein the substrate preferably is a temperature sensitive substrate, preferably MDF, wood, plastic, composite or temperature sensitive metal substrates like alloys and
b. heating to a curing temperature Tcur between 75 and 160° C., preferably between 80 and 150° C. and more preferably between 80 and 140, 120 or even 100° C., preferably using infrared heating, wherein the melt viscosity at the curing temperature Tour is preferably less than 60 Pas, more preferably less than 40, 30, 20, 10 or even 5 Pas;
c. and curing at Tour for a curing time preferably less than 40, 30, 20, 15, 10 or even 5 minutes.

18. Articles coated with a powder having a the powder coating composition according to claim 1, wherein the articles preferably have a temperature sensitive substrate preferably selected from the group of MDF, wood, plastic, composite, or metal alloys and wherein preferably the crosslinking density XLD is at least 0.01, preferably at least 0.02, 0.04, 0.07 or even 0.1 mmole/ml (as determined by DMTA) and is preferably lower than 3, 2, 1.5, 1 or even 0.7 mmole/ml.
